(19) United States
(12) Patent Application Publication
(10) Pub. No.: US 2010/0054551 A1
(43) Pub. Date: Mar. 4, 2010

(54) USE OF FINGERPRINT RECOGNITION EQUIPMENT FOR THE AUTHENTICATION OF SHEET-LIKE ITEMS

(76) Inventor: Eric Decoux, Matran (CH)

Correspondence Address: FOLEY & LARDNER LLP, 111 HUNTINGTON AVENUE, 26TH FLOOR, BOSTON, MA, 02199-7610, US

(21) Appl. No.: 12/312,698

(22) PCT Filed: Nov. 22, 2007
(86) PCT No.: PCT/IB2007/003580

§ 371 Date: May 21, 2009

(30) Foreign Application Priority Data
Nov. 23, 2006 (IB) IB2006/003324

(51) Int. Cl. G06K 9/00

(52) U.S. Cl. 382/124

(57) ABSTRACT

The invention discloses the use of biometric fingerprint sensing equipment and corresponding data processing algorithms for the authentication of printed documents or products, in particular intaglio printed indicia on banknotes, value, or identity documents. A corresponding authentication device is also disclosed.

### FIELD OF THE INVENTION

The invention is in the field of the automated recognition of items. In particular, it concerns the recognition and authentication of sheet-like items, such as currency, value and identity documents, using fingerprint sensors.

### STATE OF THE ART

The automated recognition and authentication of paper currency, branded goods and identity documents is of increasing concern. Such authentication most often relies on the proper recognition of information carried by sheet-like items, such as banknotes, product labels or passport personal identification pages.

A sheet-like item, in the context of the present disclosure, shall be understood as a two-dimensionally extended object, wherein the third dimension is small compared with the first and the second dimension; examples for sheet-like objects are a paper sheet, a textile sheet, a cardboard, a plastic foil, a credit card, or the like.

A security item, in the context of the present disclosure, is a value-document, identity-document, card, label, etc., which needs to be protected against copying and counterfeiting.

Traditional authentication needs were mainly perceived in the field of banknote authentication. Banknotes lend themselves to visual and tactile authentication by the human user, through a number of physical features which are almost exclusively reserved to currency. Among these features, intaglio printed indicia are probably the most preeminent ones.

Intaglio printing (Engraved Copperplate printing) is an important printing process used in the production of currency. In this process, an engraved copper plate (or a nickel replica thereof) is inked with a high-viscosity, pasty ink, and its surface is wiped clean again. The ink remaining in the plate's engraving is subsequently transferred under high pressure onto currency paper. The so produced intaglio printed features have a characteristic touch, which is a consequence of the compression of the paper during the printing process, and of the relief of the printed feature, jointly produced by the ink thickness and the partly embossed paper.

This characteristic touch is what people in the street are used to feel as “currency”. However, as easy it is for the human user to identify intaglio printed indicia on currency, as difficult it resulted in the past to realize an automated device which would detect and authenticate this type of printed feature.

First approaches to automated intaglio authentication went along an indirect route: U.S. Pat. No. 3,599,153 (Lewis, US Banknote Corporation) discloses the magnetic reading of intaglio printed indicia; the printed intaglio ink must herein contain a magnetic pigment. Similar approaches were disclosed in U.S. Pat. No. 3,463,907; U.S. Pat. No. 3,778,598 and in JP2002269616A2. The method is selective for intaglio printing, because other printing techniques do not deposit a sufficient amount of magnetic material. These methods are, however restricted to the scanning along one or several lines on a document printed with magnetic Intaglio ink; they do not provide a general 2-dimensional image of the printed intaglio pattern.

A direct approach to automated intaglio authentication via an optical route was disclosed by Sidler et al. in U.S. Pat. No. 4,594,514 and EP 88 169 B1 “Copperplate printing detection method and device therefore”. The document under test is herein illuminated under an angle of about 45°, causing the intaglio-printed relief to produce characteristic shadows, which are then read by a photocell. Flat, non-intaglio printed indicia do not produce a similar signal under the disclosed conditions. Similar approaches were disclosed in U.S. Pat. No. 3,634,012 (Mustert); as well as in JP06171071A2; JP06301840A2; JP2003248852A2 and in JP2001236544A2. These methods allow for a non-contact detection of intaglio printed indicia and, using a camera in place of the simple photocell, are able to provide a 2-dimensional image of the printed pattern; however they depend on complicated and voluminous optical set-ups which are hardly amenable to miniaturization.

Another, direct way of intaglio authentication was disclosed by Bayha in U.S. Pat. No. 3,583,237 (ARDAC/USA). A mechanical stylus is used to track the surface of the document, and the mechanical vibrations produced are taken as a characteristic of the relief of the intaglio printed indicia on the latter. Similar technology, using brushes instead of a stylus, and acoustic detection means, has been disclosed by Ross in U.S. Pat. No. 5,974,883; EP 880 114 B1 and U.S. Pat. No. 6,253,603, as well as in JP09106466A2. However, these mechanical scanning methods do not provide for a 2-dimensional image of the printed intaglio pattern.

The technology disclosed in the prior art does thus not provide for a direct, 2-dimensional imaging of a printed intaglio relief pattern on a document without the implication of voluminous optical set-ups.

### SUMMARY OF THE INVENTION

It was now surprisingly found that the miniaturized equipment used for the capture of biometric fingerprint relief patterns is perfectly suited for the capture of image data of intaglio relief patterns on banknotes and other intaglio-printed documents, provided certain conditions disclosed hereafter. It was also found that image data of a variety of other features on documents or items can be acquired with the help of this type of equipment.

Fingerprint reading technology has been developed for biometric identification purposes and is currently available from a large number of different suppliers. Corresponding sensor chips are made by many of the large semiconductor manufacturers such as ATMEL, Casio, Fujitsu, AuthenTec, Sony, ST-Microelectronics, Infineon, Philips, Hitachi, NEC, Ethentica, and others.

A number of different physical principles are applied in such sensors, each being able to yield information about a human finger's micro-grooves:
a) Frustrated (attenuated) optical total reflection at a glass plate (U.S. Pat. No. 4,805,223), in conjunction with a 2D-CMOS camera, yields an 2D-image of the touching parts of an object (e.g. a finger), disposed on top of the said glass plate; sensors of this type are also available as 1D-scanning sensors, wherein the object (finger) must be swept over the sensitive area;
b) Thin-Film-Transistor Displays can be exploited as optical sensors and are able to retrieve the fingerprints from a finger applied onto their top glass (U.S. Pat. No. 7,023,503; U.S. Pat. No. 7,009,663; U.S. Pat. No. 5,325,442; WO2004/036484A1; Jeong Hyun Kim et al., “Fingerprint Scanner Using a-Si: H TFT-array”, SID '00 Digest, May 14, 2000);
c) Microelectronic capacitance sensors, having an extended array of microscopic capacitor plates, can be used to sense the close proximity of an object, and thus to precisely localize the groves and the hills of a touching finger, i.e. the fingerprint (U.S. Pat. No. 4,353,056; U.S. Pat. No. 5,952,588; U.S. Pat. No. 6,643,389);
d) Conductive membrane sensors with a corresponding, micro-structured electrode array, can also be used to sense a fingerprint (U.S. Pat. No. 4,577,345);
e) Tactile micro-electromechanical devices (MEMS) can sense a surface relief (pressure sensor: EP 769 754 B1; U.S. Pat. No. 7,013,013; U.S. Pat. No. 5,844,287; U.S. Pat. No. 4,394,773);
f) Thermic (microbolometric, pyroelectric, or photoelectric) sensors are a newer choice for the retrieval of fingerprints from living subjects (U.S. Pat. No. 6,459,804; U.S. Pat. No. 6,061,464; US 2004/0208345 A1);
g) Ultrasonic sensors have also been used to retrieve fingerprint information (U.S. Pat. No. 4,385,831);

According to the present invention, and provided certain conditions, fingerprint reading equipment of any of these technologies known and used in the art can be used for the authentication of a sheet-like item. The sheet-like item may herein be a paper, a plastic, a cardboard, a textile, and the like.

The fingerprint sensor may further be of the one-dimensional, scanning array type, or of the two-dimensional, static array sensor type. The image data retrieved by the sensor can be used to authenticate the item, by comparison with pre-recorded data corresponding to an original item. The term “image data”, in the context of the present disclosure, encompasses any digital output furnished by said sensor in response to a sensed image.

The essential point herein is that the sensor is able to discriminate between local variations of a characterizing physical property in the sheet-like item. The authentication can be based on at least one characterizing physical feature produced in or on the item.

Such characterizing feature may be derived from intrinsic properties imparted to the item during the manufacturing process. Alternatively, they may be introduced as printed features, preferably an intaglio printed feature, contained on at least one of the recto or verso side of the sheet-like item.

Certain type of sensors, in particular the thermic sensors, discriminate well between the high and the low portions of a relief on the sheet-like item, rather than to be primarily sensitive to the printed color. They are therefore particularly suited for the authentication of intaglio printed indicia on currency and other documents; i.e. they are able to distinguish between those parts of the item which are slightly closer to the sensor surface, and other parts of the item which are slightly apart from the sensor surface. The height variations in a fingerprint being comparable to those of intaglio printed indicia, fingerprint sensors are indeed suited to acquire image data of the relief of an intaglio printed document.

Particularly preferred in the context of the present invention is a thermic sensor, such as a microbolometric, a photoelectric, or a pyroelectric sensor.

The sensor may herein be either of the static, or of the scanning type. In the first case, the specimen is disposed on or in the sensor, or, alternatively, the sensor is disposed on the specimen. In the second case, the specimen is manually or mechanically moved over the sensor area, or, alternatively, the sensor is manually or mechanically moved over the specimen area of interest.

Fingerprint sensors are generally available equipment; in fact, biometric fingerprint scanning equipment is being popularized for all kind of access control and user identification. This is an advantage for the present application, in that the new use of this kind of already available equipment for testing the genuineness of banknotes, passports, etc. . . . is thus easy to implement and merely requires a corresponding image processing algorithm, implemented through a program patch.

### DETAILED DESCRIPTION

Inventors have successfully used different types of fingerprint sensors to acquire image data of intaglio relief printed indicia from banknotes or other intaglio printed documents for authentication purposes.

More generally, inventors have found that any sheet-like item, e.g. woven or non-woven materials, can be authenticated in such way. The authentication feature, i.e. the feature which is detected by the sensor, can be a relief pattern, a woven mesh pattern, a watermark, a density pattern, or any other pattern of a measurable characteristic.

According to the present invention, the fingerprint sensor can either be a one-dimensional-array or a two-dimensional-array sensor.

Said fingerprint sensor can be chosen from the group consisting of frustrated optical total reflection sensors; thin-film-transistor optical sensors; microelectronic capacitance sensors; conductive membrane sensors; tactile micro-electromechanical sensors (MEMS); ultrasonic sensors; and thermic sensors; of the latter pyroelectric sensors, photoelectric sensors, and microbolometric sensors are particularly preferred.

Thermic fingerprint sensors are based on an array of semiconductor circuits, capable to reveal tiny temperature differences between high and low areas on a document. They were found particularly suitable for the acquisition of a printed intaglio relief pattern.

In the case of photoelectric sensors, the quantum energy of thermal infrared radiation is directly exploited via the internal photo-effect in an appropriate semiconductor material. Due to the comparative smallness of the said quantum energy, these detectors must be cooled to cryogenic temperatures during operation, to reduce perturbations by the radiation from the environment.

Microbolometric sensors simply detect the cumulated thermal energy of the incident infrared (and/or other) radiation, and produce a corresponding voltage signal at each pixel. Said voltage is representative of the pixel's temperature, with respect to a reference temperature, which is generally taken as the temperature of the semiconductor chip. The voltage may herein originate in thermoelectric or thermo-resistive effects, depending upon the construction of the sensor. Microbolometric sensors are in principle static devices.

Pyroelectric sensors as well detect the cumulated thermal energy of the incident infrared (and other) radiation; however, the said radiation is generally collected by a pyroelectric foil of poled polyvinylidene fluoride, dynamically producing electric charges upon every slightest change of temperature. The pyroelectric foil, in turn, is disposed on top of an array of field effect transistors, whose gates are triggered by the electric charges developed by the pyroelectric material. The pyroelectric sensor is sensible to temperature changes, and is thus principally a dynamic device, aimed for scanning detection.

To authenticate a sheet-like item, the respective part of the item in question is put in contact with the fingerprint detecting area of the sensor, or the fingerprint sensor is put in contact with the respective part of the item, whereby image data of the pattern are acquired by a computer or processor connected to the fingerprint sensor. The retrieved data is subsequently used for the authentication of the item.

In the case of a pyroelectric sensor, the respective part of the item in question is swept over the fingerprint detecting area or the fingerprint sensor is swept over the respective part of the item.

The pyroelectric sensor reveals a temperature change in time; it is thus particularly suited for the scanning type detection. In fact, this sensor type does not respond to a merely static temperature difference, but the item must be dynamically swept over the sensor array for the acquisition of the pattern.

The pyroelectric sensor comprises a heating element, whose temperature is kept slightly above ambient temperature, and which is disposed so as to precede the sensor's sensitive area, in line with the scanning direction. The item must be swept at an appropriate speed over the heating element and the following sensor area, in order to acquire an image.

Other types of thermic sensors, such as the microbolometric or the photoelectric arrays, are sensitive to static temperatures or temperature differences. They can be used as well to embody the present invention, e.g. as a 2-dimensional sensor array in a camera-like embodiment, which does not require sweeping.

The image acquired by a thermic sensor, i.e. the origin of the image data, is of thermal nature, in that it reflects the tiny temperature differences which appear on an item's, e.g. a document's surface after this latter has been shortly exposed to the heating element.

The heat uptake of the sample surface depends noteworthy on the sample's local topography, and, in consequence, the thermal image reflects the said local topography of the sample.

Said local topography may comprise relief, such as the surface relief produced by intaglio printing, as well as mesh pattern, density variations, thermal conductivity variations, etc. All of them can give rise to a said thermal image. Furthermore, it has been found that even relief present at the backside (i.e. the document's surface which is opposed to the scanned surface) is revealed in such thermal image. The thermal image is thus in particular able to reveal a recto verso intaglio printing through a simple one-side scanning.

To identify or authenticate an item or a document, data corresponding to a characteristic part of an original item, carrying an authentic pattern, can be pre-recorded as a specification in a memory of the authentication device, alternatively in a remote server connected to the said device, and the image data obtained from the item in question can be compared with the stored information, using an appropriate algorithm and authenticity criterion. The result of said comparison indicates whether the item or document in question matches the specifications of the original, or not.

The thermal image also reveals embossing, such as can be obtained through inkless intaglio printing. Further, the thermal image has been shown to reveal “indented writings”, such as are produced on a sheet of paper by the pressure effects caused by writing to a sheet disposed on top of it, or even several sheets on top of it. These “indented writings” are useful in particular for document examination in the field of forensic science.

A capacitive sensor can be used in an alternative embodiment; however, this type of device has been found to be sensitive to metallic or metallized objects only (metallic intaglio printing, metallized paper, textures, etc. . . . ). The metallic printing or the metallized paper are electrically conducting and allow for the electric charging/discharging of the sensor's capacitors. Capacitive sensors can furthermore be either of the static or of the high-frequency type; static sensor rely on the omnipresent environmental electric fields, whereas high frequency sensors rely on an alternating electric field of determined frequency, which is applied on purpose.

Other sensor types, noteworthy ultrasonic sensors, may also be used in other embodiments of the present invention. Preferred, however, is a thermic sensor. Said thermic sensor is noteworthy sensitive to the intaglio printing/embossing of a banknote or another intaglio imprinted document. In case of an unprinted paper, said sensor is also able to reveal an image of the paper's fiber texture.

A thermic sensor is therefore able to detect paper characteristics, which can be taken as an intrinsic signature of a genuine paper. This signature may derive from properties imparted to the paper during the manufacturing process, in particular by the screen used for the dewatering of the paper pulp. Such screens are typically made as a wire mesh having a regular spacing and a typical pattern.

Paper signatures may also be introduced through other operations at the paper mill, such as the generation of watermarks (paper thickness modulations, paper density modulations), or the on-purpose embossing of the paper. The paper may furthermore be imprinted with colorless varnish, to produce watermark imitations.

The thermal image retrieved from genuine paper may thus contain various types of signatures, which allow the skilled person to distinguish one type of paper from another. These paper signatures are stable over time and remain present even if a particular sheet of paper is damaged by crumpling, rubbing etc.

Creases may disturb the detection of determined patterns or paper signatures, but such perturbations do not have the same characteristics as the information to be retrieved, which means that they can be filtered out by appropriate image processing algorithms. To obtain the paper signature, independent of the printed features carried by the paper, the most appropriate place on the document (e.g. a banknote) can be used.

The thermic sensor also retrieves surface textures differing in thermal emission. It will thus also reveal to a certain extent a flat printing made with black or colored ink of lower or higher thermal emission than its surroundings.

When a document carrying recto-verso intaglio printed indicia is scanned on a single side by a thermic fingerprint detector, the superposed relief images of both sides (recto and verso) can be retrieved through a single one-side scan. This allows e.g. for the authentication of a recto-verso intaglio printed banknote via a simple one-side scan. An imitation of the banknote by non-intaglio printing techniques cannot produce said superposition of recto and verso relief through a single scan of the fingerprint detector, and is thus easily recognized as non-authentic.

In a further embodiment, the fingerprint detector is used to authenticate a woven material, in particular a textile. A textile can noteworthy be internally marked through a particular woven mesh pattern; such pattern can be easily generated on a numerical weaving loom. The marked textile can then be used, e.g. as a label for branded textile goods. The image processing algorithm of a scanning-type fingerprint sensor generally comprises an image acquisition and an image reconstruction part. The image acquisition part acquires a sequence of image frames, at an adequate resolution, of a part of the fingerprint. The image reconstruction part assembles the acquired frames to form a complete image of the fingerprint. The image data are then available for further processing.

The pyroelectric scanning sensor used in certain embodiments of the present invention delivers e.g. a sequence of frames, each of 8×280 pixels, at 4-bit intensity resolution. Successive frames are assembled by the image reconstruction algorithm to form a complete image of the fingerprint, taking into account their mutual overlap. The reconstructed image data can then be used to identify the sheet-like item.

According to a first embodiment, a thermic sensor, e.g a pyroelectric, microbolometric, or photoelectric sensor, is used for the authentication of a sheet-like security item, such as a printed document or a label; the item is herein put in contact with the sensor area, so as to acquire image data, and the image data, or at least part of it, or data derived thereof, is compared with pre-recorded data corresponding to an original item, and an authenticity result is derived, using an appropriate algorithm and a predefined authenticity criterion.

According to an alternative, preferred, embodiment, the image data is first treated with a signal processing algorithm, which may comprise transform and/or filter functionality, and subsequently compared with pre-recorded data. Said signal processing may in particular comprise high pass filtering, to remove background noise, and/or low pass filtering, to remove creases and scratches.

Said signal processing may further comprise mathematical transforms, in particular Integral Transforms (such as a Fourier, Laplace, Mellin, Hankel, Abel, Hilbert, Hartley, Radon, Wavelet, Stirling, Hadamard or Z-Transform), preferably a Fourier transform.

The result of a Fourier transform is independent of lateral translations which may occur during the image acquisition. This independence facilitates the identification of a determined signature or pattern. The use of a Fourier transform is also recommended by reasons of robustness. Each point of the Fourier transformed data set being noteworthy dependent on each point of the original data set, a loss of a part of the original data, such as may occur through partial destruction, does not, thus, affect the Fourier transformed data other than increasing its background noise. A Fourier transformed signature is therefore extremely resistant to soiling and crumpling.

Said transform of the image data may either be performed as a 2-dimensional transform, or, preferably, reducing the transformed data to a radial distribution, as a 1-dimensional representation, which is independent of orientation (scanning direction). The invariance to rotation i.e. the invariance of the retrieved information from the chosen scanning direction, enables a rapid identification of an item in practical applications.

In still another embodiment, a 2-dimensional Fourier transform can be used to detect an intentionally embedded signature in a sheet-like item. To this aim, a number of discrete “signature points”, forming e.g. the logo of a Central Bank, are defined in a 2D Fourier Graph, and the corresponding line spacing and directions are calculated and embodied through a printing technique, e.g. as discrete zones in different parts of an intaglio image. Only the Fourier transform of the image data will then reveal the hidden signature. As is obvious to the skilled person, such signature can also be realized by other printing processes (printing outlines, etc.); furthermore it may be embedded in the paper or substrate of the sheet-like item, e.g. as a watermark.

In a more generalized way, a whole signature image may be defined in the 2-D Fourier graph, and the corresponding pattern in real space can be calculated through an inverse Fourier transform. Arranging for a transformed pattern having real values only, the pattern can be embedded in the paper or substrate of the sheet-like item, e.g. as a watermark, or else, embodied as printed indicia on the sheet-like item. The signature image corresponding to the pattern will only be revealed by the Fourier transform of the image data. Such signature is highly resistant against damaging (crumpling, soiling) of the paper.

As is obvious to the skilled person, said embedded signatures may furthermore be encrypted, so as to be only accessible via the appropriate decryption key.

Alternatively, the dominant directions of a printed intaglio stroke-pattern can be determined in the image data, using a suitable algorithm, and image areas having a similar orientation of the engraved strokes can be delimited and compared with corresponding pre-recorded data obtained from an original. Said comparison may e.g. be aimed at identifying a characteristic shape or determined indicia in the printed pattern, for authentication purposes.

Also disclosed is a method for authenticating a sheet-like item, comprising the steps of a) putting the item in contact with a fingerprint sensor as disclosed above; b) acquiring image data from the fingerprint sensor, said data being representative of at least one characterizing feature comprised in or on the item; and c) comparing the image data with reference data corresponding to an original item, using an appropriate algorithm and an authenticity criterion, herein deriving an authenticity result. Said acquisition of the image data can be performed in scanning mode, using a one-dimensional-array fingerprint sensor, or in static mode, using a two-dimensional-array fingerprint sensor.

A further method for authenticating a security item, such as a value document or a label, is characterized by the steps of a) sweeping the item over the sensor area of a pyroelectric fingerprint sensor, or vice-versa, b) acquiring image data of said item, and c) comparing the said image data, or data derived thereof, with pre-recorded data corresponding to an original item. Said image data may be representative of a printed feature, preferably an intaglio printed feature, on said item.

In still a further method according to the invention, said image data is acquired from a single, first side of said item and said acquired image data is representative of information present on both, a first and a second side of said item. According to the invention the image data may be treated with a signal processing algorithm, comprising transform and/or filter functionality, prior to its comparison with pre-recorded data. The transform can be a 2-dimensional transform, preferably a Fourier transform; preferably the 2-dimensional transform is reduced to a 1-dimensional representation, to facilitate a rapid authentication.

In a particular method for authenticating a sheet-like item, such as an intaglio-printed document, a conjunction of a first thermic sensor for acquiring image data from the recto-side of the item, and a second thermic sensor for acquiring image data from the verso-side of the item is used. In this way, the authenticity of, e.g. intaglio printed indicia can be confirmed or infirmed through a single scan of the item and a subsequent correlation of the respective image data retrieved. Non-intaglio printing techniques are noteworthy not able to reproduce the characteristic, recto-verso-visible embossing effect of intaglio printing.

In a further embodiment of the present invention, a document authentication device comprises a combination of at least one fingerprint sensor, preferably a thermic sensor, and of at least one optic sensor, as well as processing means for treating and correlating the acquired images from both sensors and to derive an authenticity result.

The fingerprint sensor, on the one hand, captures an image of the ridges and valleys produced in the document, e.g. by the intaglio printing process. The optic sensor, on the other hand, captures an image of the colored printed ink features, such as guilloches or portraits, on the document. Documents produced by the intaglio printing process will thus produce a same image at both sensors, once as embossed ridges and valleys, and once as colored ink features. Both, the fingerprint and the optic sensors, can be arranged so as to capture the same part of the document simultaneously, for example if the embossed image is captured e.g. by a thermic sensor at the back side, and the colored ink features e.g. by an optic sensor at the front side of the document.

The treatment and correlation of said images acquired by both types of sensors is performed by processing means, and allows the determination of the authenticity of e.g. an intaglio-printed document inserted into the authentication device. The device according to this embodiment noteworthy provides a robust authentication of intaglio-printed documents, in particular banknotes, because it allows for the discrimination of intaglio imitations showing no embossing corresponding to the printed features.

Said optic sensor comprises an image captor, which can be embodied e.g. as CCD- or a CMOS-area or line-scan camera, together with an image forming system, which can be embodied e.g. as lens or a Fresnel lens, optionally an image redirection system, which can be embodied e.g. as a prism, a mirror, or a fiber optics, optionally a filter system which can be embodied e.g. as a high-pass, a low-pass, a band-pass, a notch, a polarization filter, or as a combination thereof, or as an electro-optic filter, and an illumination system, which can be embodied e.g. by at least one monochrome or polychrome Light Emitting Diode (LED), emitting in the ultraviolet (200-400 nm), visible (400-700 nm) or infrared (700-2500 nm) wavelength range, with particular preference for white LEDs.

The document is preferably authenticated in scanning mode, i.e. each a line of the image is retrieved at a time by each, the optic and the fingerprint sensor. Both types of sensors are accurately positioned with respect to each other to allow for a precise correlation of both streams of data retrieved by the optic and the fingerprint sensor, respectively. An acquired image from the optic sensor, revealing a printed color pattern on the recto side of an intaglio-printed document shall thus correspond to an acquired image from the fingerprint sensor revealing a ridge-and-valley relief on the verso side of the same document. Intaglio imitations, such as flat printings on an indifferently embossed paper, will not show correlation between the optic image and the relief image on the recto and verso sides respectively.

Inside the document authentication device, the document to be authenticated is moved forward in a guiding track, using appropriate holding and transportation means, so as to hold the document in the focal plane of the optic sensor and in contact with the fingerprint sensor, and to move it through the device at appropriate speed. The document may be moved by hand, in which case preferably an encoder is provided to retrieve the actual speed of movement, or, alternatively, it may be moved with the help of appropriate electromechanical means.

As is obvious to the skilled person, the herein disclosed technology can be used for banknotes, value documents, identity documents and the like.

Further disclosed is a system for authenticating a sheet-like item, comprising a fingerprint sensor, an electronic processing device, and a data processing algorithm implemented on said processing device.

The present invention also discloses the use of a fingerprint sensor as part of an automated cash handling machine, such as an Automated Teller Machine (ATM) or an Automated Vending Machine (AVM), aimed at the authentication of value documents, such as banknotes.

The invention is now further illustrated with the help of figures and exemplary embodiments.

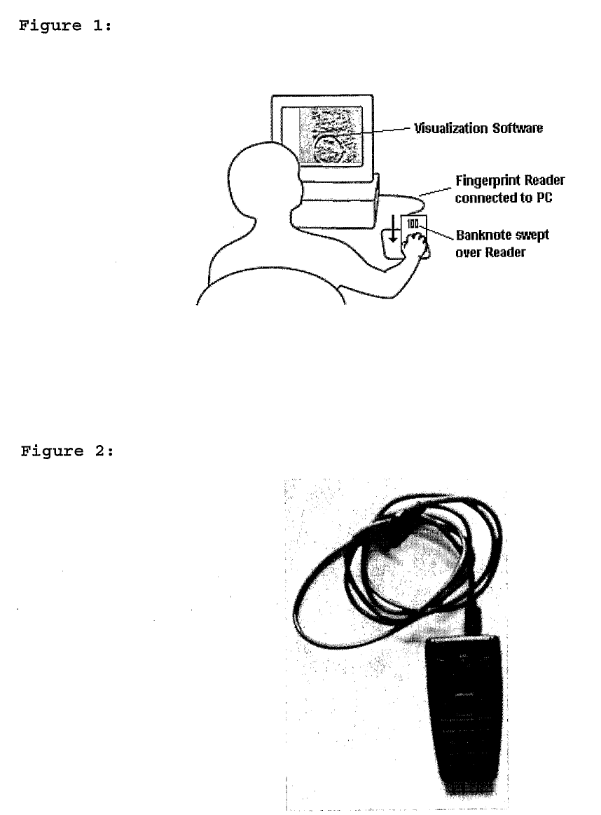

FIG. 1: schematically illustrates the use of a pyroelectric sweeping fingerprint sensor for the authentication of intaglio printed indicia on a document.

FIG. 2: shows a picture of the pyroelectric fingerprint sensor AT77C104B-EK3 manufactured by ATMEL

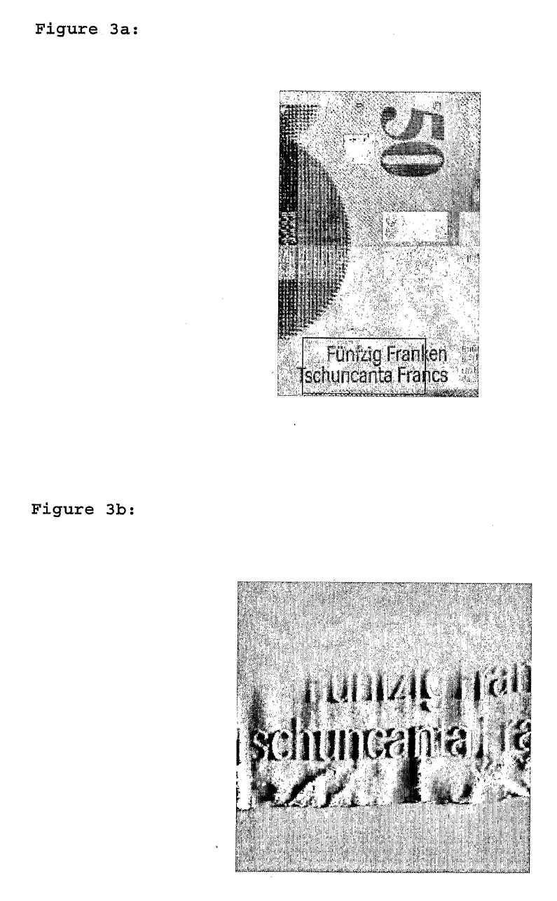

FIG. 3: a) shows part of a 50 CHF Swiss Banknote, taken from circulation;
b) shows part of the intaglio printed indicia image data, corresponding to the denomination printing on the note, as acquired by the pyroelectric sensor.

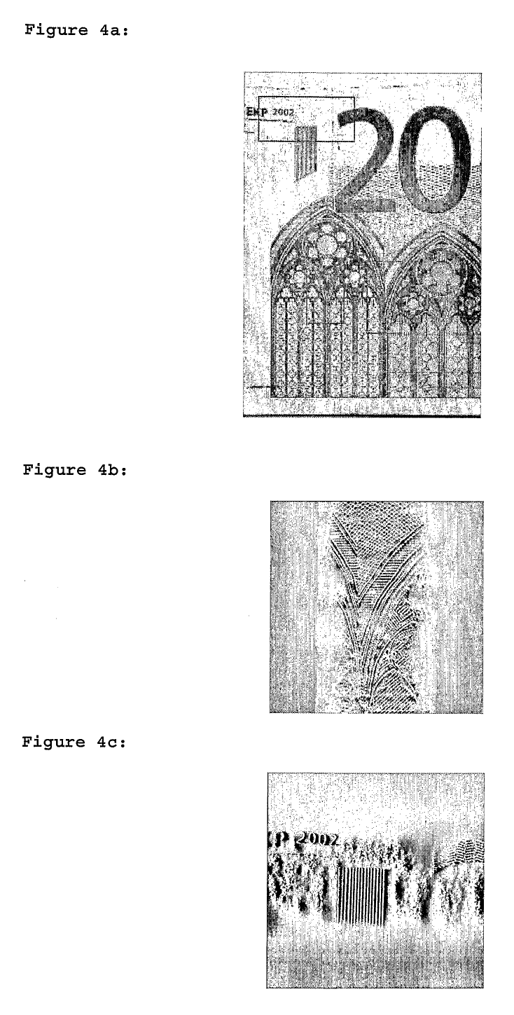

FIG. 4: a) shows a part of a 20 Euro Banknote, taken from circulation;
b) shows image data of a detail of the fine line intaglio pattern from the arch jointure;
c) shows image data of a detail of the ISARD intaglio line pattern.

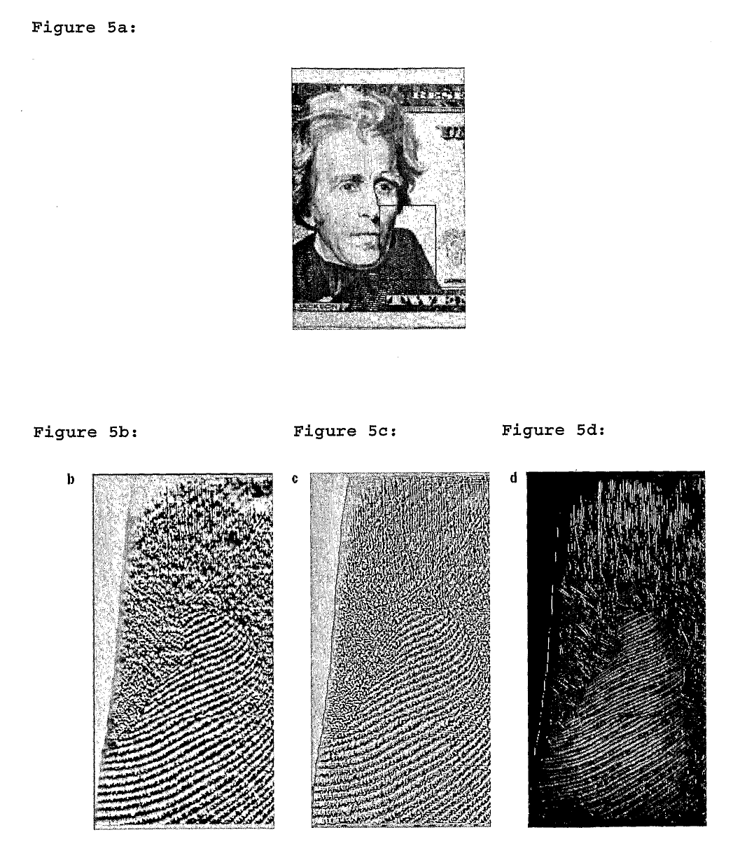

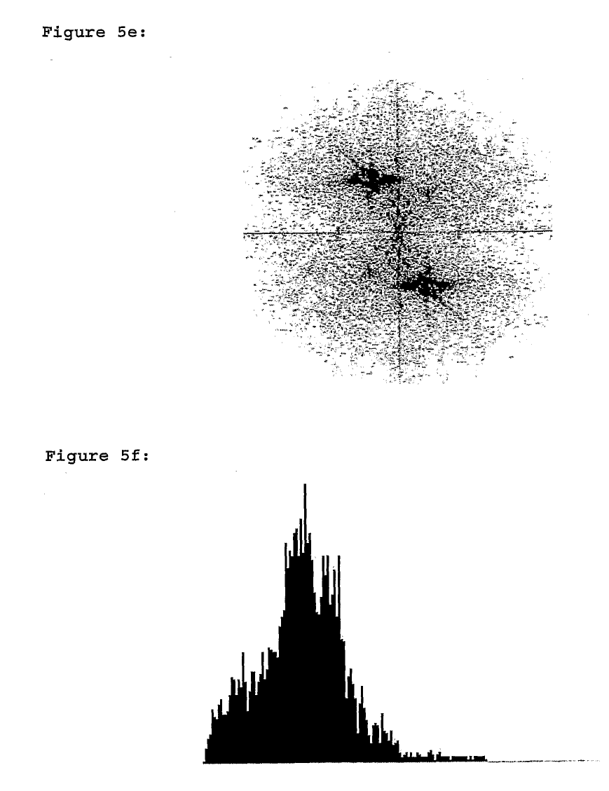

FIG. 5: a) shows part of a 20 USD Banknote taken from circulation.
b) shows image data of the intaglio printing, as obtained in the indicated zone, but taken from the back side of the note.
c) shows the same image data after digital filtering to remove creases, scratches and noise,
d) shows a delimited zone of dominant direction of intaglio strokes, as identified by an algorithm,
e) shows a 2D-Fourier transform of the image data as obtained in FIG. 5b).
f) shows a 1D-reduction of the 2D-Fourier transform of FIG. 5e).

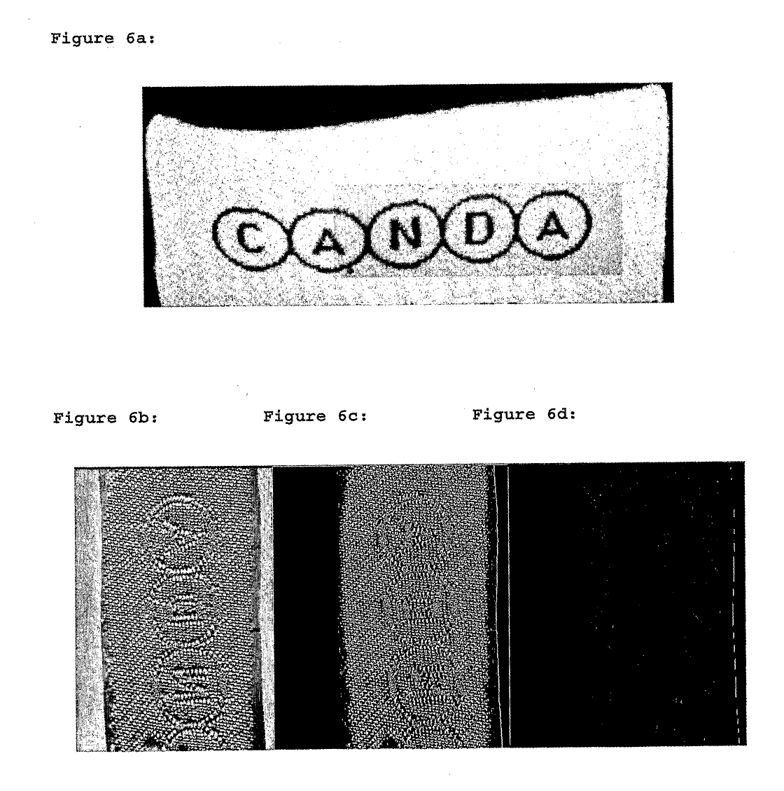

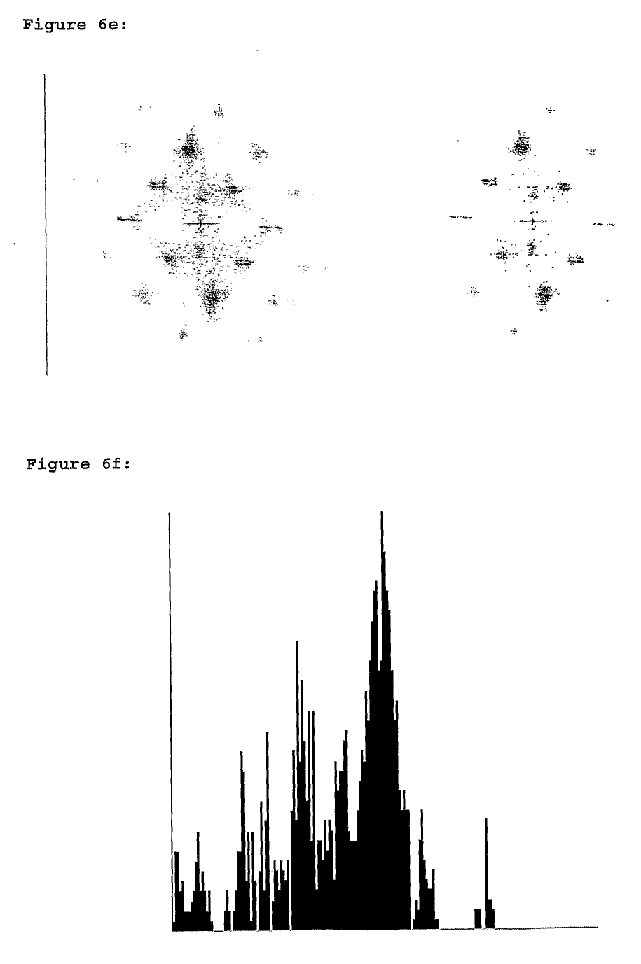

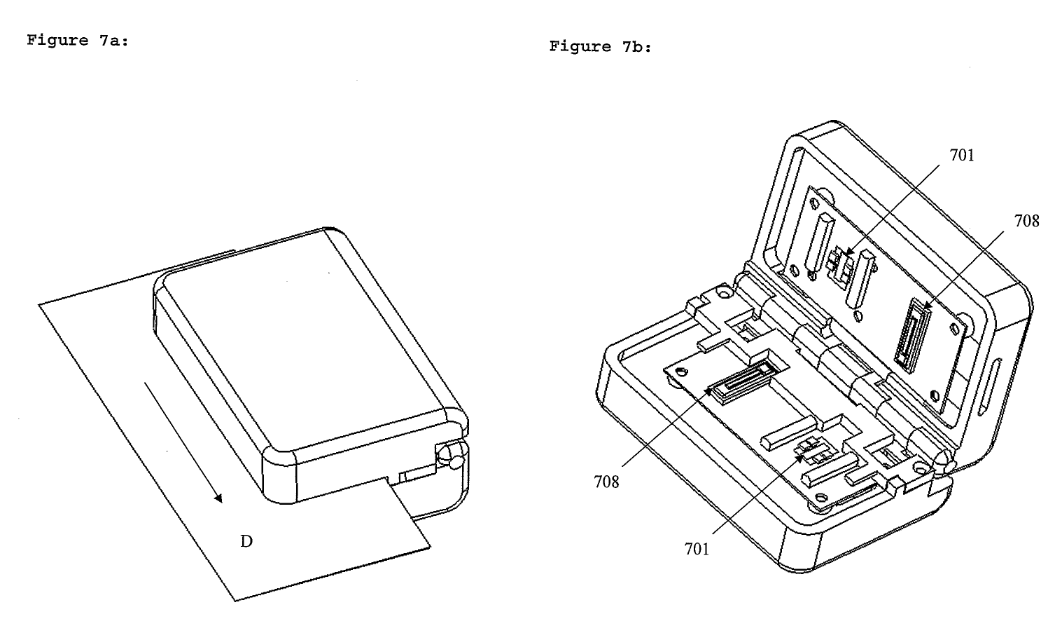

FIG. 6: a) shows a textile label;
b) shows image data of the textile label, as obtained from the indicated zone;
c) shows the same image data after digital filtering to remove creases, scratches and noise;
d) shows delimited zones of dominant direction, as identified by an algorithm, of the same image data;
e) shows a 2D-Fourier transform of the image data as obtained in FIG. 6b);
f) shows a 1D reduction of the 2D-Fourier transform of FIG. 6e).

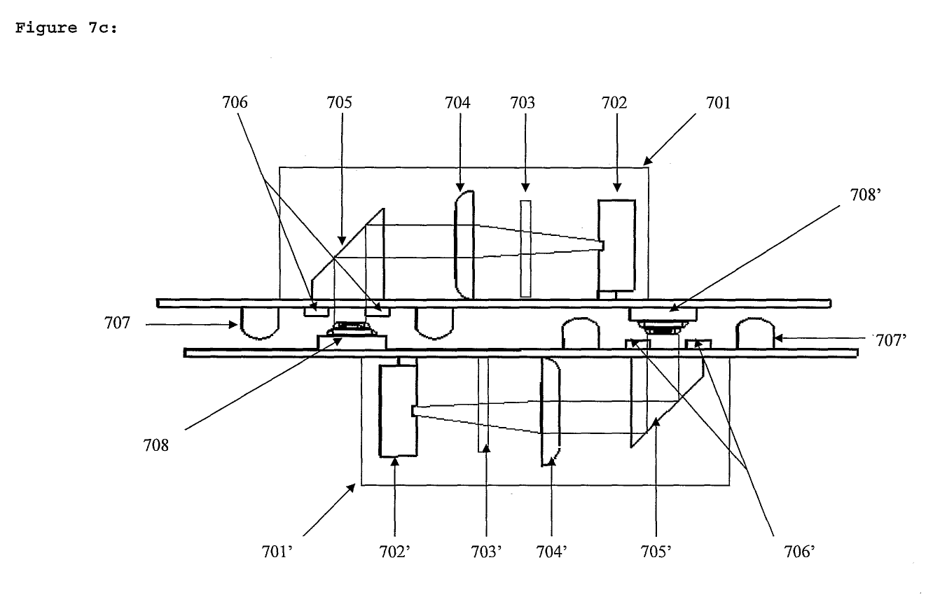

FIG. 7: shows an example of a document authentication device for the simultaneous capturing of relief and optical image data:
a) the closed authentication device, with a document (D) inserted, indicating the scanning direction;
b) the opened document authentication device; both, the top and the bottom part of the device contain each an optic sensor (701) and a thermic sensor (708); the sensors are mutually aligned so as to capture the combined optic and relief images of both, the top and the bottom part of the document;
c) a schematic cross-section through the closed document authentication device.

In a first exemplary embodiment, according to FIG. 1, a thermic fingerprint sensor (ATMEL AT77C104B-EK3, FIG. 2), was used to acquire image data of intaglio printed indicia on new and used banknotes. For each banknote, a region providing intaglio printed indicia was swept over the sensor at appropriate speed (about 5 cm/second). The sensor returned image data of the ridges and valleys characterizing the intaglio relief print (FIGS. 3b, 4b, 4c, 5b).

FIG. 3a illustrates part of a 50 CHF Swiss Banknote from circulation, which was swept over the fingerprint detection area of the ATMEL thermic sensor. FIG. 3b shows the thermal image data obtained from the localized frame indicated in FIG. 3a, i.e. the intaglio printed indicia corresponding to the denomination “Funfzig Franken”. The characters of the Intaglio denomination printing are clearly identified, together with visible traces of paper crumpling, due to the use of the note in circulation.

Similarly, FIG. 4 shows part of a 20ε banknote with two frames indicated on it. FIG. 4b shows the thermal image data of the intaglio details corresponding to the arch jointure; FIG. 4c shows the thermal image data obtained from the ISARD intaglio line pattern.

To identify (authenticate) the banknote, reference data corresponding to a characterizing features of original intaglio-printed indicia was pre-recorded in a memory of the authentication device, and the image data obtained by scanning the questionable document was compared with the pre-recorded data, using an appropriate algorithm. The result of said comparison was used to indicate whether the document in question matched the specifications of the original, or not, according to a predefined authenticity criterion.

FIGS. 5 and 6 show the effect of various signal processing treatments, which can be applied to the acquired thermal raw image data, in order to increase the accuracy and/or visibility of determined characterizing features, or to derive a characterizing authentication signature. FIG. 5a shows part of a 20 USD note from circulation, having an intaglio printed portrait (Andrew Jackson) on its recto side. FIG. 6a shows a textile label. FIGS. 5b, 6b show, respectively, the thermal image data obtained from the indicated zones in FIGS. 5a, 6a. The image data of the 20 USD note was herein acquired from the back side of the intaglio printed portrait; the relief printing being accessible from both sides of the banknote. The thermic sensor is noteworthy able to detect recto-verso intaglio-printed indicia in a single, one-side scan of the imprinted paper. Such detection of a two-side intaglio image data through a simple on-side scan is unique.

FIGS. 5c, 6c show the same image data after digital signal processing operations have been performed on them; noteworthy low-pass and high-pass filtering to get rid of creases, scratches, and high-frequency noise components, respectively.

FIGS. 5d, 6d show orientation maps, which were obtained from FIGS. 5c, 6c, respectively, through the application of the following algorithm:

For each point of the image, the sum of n neighboring pixels in a line is taken along a number of selected directions ‘round the clock’, and the best orientation of the lines at this point is determined on the basis of a maximum value obtained.

Based on the orientation map so obtained, zones of the image having a similar orientation of the engraved strokes can be delimited and compared with pre-recorded data obtained from an original. The result of said comparison indicates whether the document in question matches the specifications of the original, or not, according to a pre-established authenticity criterion.

The orientation map is particularly useful in the case of intaglio prints, consisting of more or less regularly spaced line strokes having a more or less same direction in a determined area. FIG. 5d illustrates the identification of such an intaglio printed area. In the case of a textile (FIG. 6d), no clearly defined stroke direction is available, due to the crossing threads of the woven material.

According to a further embodiment of the invention, a spectral data processing is performed on the acquired image data. A preferred algorithm is the Fourier transform, which takes the data from the space to the frequency domain, and allows to get rid of translation effects which can occur during the scanning operation. Since intaglio printing contains engraved lines which often run at regular intervals, the spectral representation allows to discriminate and to highlight these specific frequencies occurring in the scanned area.

FIGS. 5e, 6e show, respectively, the two-dimensional Fourier transforms of the thermal image data of FIGS. 5b, 6b. Such transform can be calculated efficiently using the Fast Fourier Transform Algorithm (FFT) of Cooley and Tukey. The 2D-FFT represents the characteristic frequencies and their relative directions in the plane of the image. The visible dark zones in FIGS. 5e, 6e show, respectively, the directions and the importance of the dominant frequency components of the original image data given in FIGS. 5b, 6b.

The characteristic features of the 2D-FFT of the thermal image data of an item in question can be used to identify the item, by comparison with pre-recorded data obtained from a certified original (reference data).

A rotation of the original image (e.g. by scanning the document in a different direction than the scanning direction used to generate the reference data) will produce a corresponding rotation of the 2D-FFT graph. As there is no translation possible, the comparison algorithm can easily take into account such potential rotation. For instance, the rotation may be accounted through a mathematical correlation of both, reference and sample data, using the rotation angle as a correlation parameter, as known to the skilled person. If the normalized correlation value approaches unity at a determined rotation angle, the genuineness of the item in question is confirmed. Alternatively, trial-and-error methods can also be used to find out whether the item in question matches the reference.

Alternatively, to eliminate the angle dependence, the 2-D Fourier transform graph can also be reduced to a one-dimensional representation. This can be achieved by a simple algorithm of the following form, wherein f(x,y) represents the 2-D Fourier transform graph, extending from (−xmax,−ymax) to (xmax,ymax), and I(r) represents the 1-dimensional representation, extending from 0 to rmax

For r:= 0 to rmax do I[r]:=0;
For x:= −xmax to xmax do begin

For y:= −ymax to ymax do begin

r:= integer(sqrt(x*x+y*y));
I[r]:= I[r] + f[x,y];
(* threshold option *)
If f[x,y] > threshold then I[r]:=I[r]+f(x,y);

End (* for y *);

End (* for x *).
(* scaling option *)
For r:=1 to rmax do I[r]:=I[r]/r

The so obtained 1-dimensional representation of the Fourier graph is a scanning-direction- and translation-independent signature of an intaglio or other pattern, and can be used to directly compare the characteristics of an item in question with corresponding reference data.

FIG. 7 shows still a further embodiment of the invention, for the simultaneous authentication, on a document, of intaglio relief and printed color features. At least one optic sensor and at least one thermic sensor are aligned with respect to each other, so as to simultaneously scan the recto and the verso side of an intaglio-printed document.

With reference to FIG. 7a, a document is inserted into the document authentication device and laterally scanned along the indicated direction. The authentication device comprises, as shown in FIG. 7b, in both, the top and the bottom parts, each an optic sensor (701) and a thermic sensor (708); the sensors are mutually aligned so as to capture the combined optic and relief images of both, the top and the bottom part of the document. The device also comprises transportation means for moving forward the document, and a guiding track to hold the document in the focal plane of the optic sensor and in contact with the thermic sensor.

FIG. 7c shows a schematic cross-section through the document authentication device. Two combinations of optic and thermic sensors are present, each two sensors of each of both types aligned face to face: a thermic sensor (708) at the bottom left is aligned in front of an optic sensor (701), comprising an image redirection system embodied as a 45°-prism (705), an image forming system embodied as a focusing lens (704), a filter system embodied as an IR cut-off filter (703), an image captor, embodied as a line-scan CCD camera (702), and an illumination system, embodied as two white LEDs (706). Holding and transportation means (707, 707′), maintaining the said document close to the said sensors, are also provided.

A second combination of optic and thermic sensors (701′, 702′, 703′, 704′, 705′, 706′, 708′) is provided to scan the document simultaneously from the opposite side. This is particularly desirable if the document contains a two-sided intaglio imprint.

The positioning of the two sensors face to face facilitates the correlation of the acquired images. A processing unit treats the acquired image data obtained by the two combinations of optic and thermic sensors. A corresponding algorithm implemented on said processing unit allows to compare the images, i.e. to identify whether the intaglio printing revealed by the optic sensors (701, 701′) matches the embossed relief revealed by the thermic sensors (708, 708′).

An ergonomic document guiding track is used to facilitate the progression of the document in the document authentication device. Holding and transportation means (707) are used to assure a correct image acquisition by the thermic and the optic sensors, in addition these said means allow to maintain the document correctly positioned in the guiding track. An encoder may be provided to enable the processing means to retrieve the actual speed of movement of the document in the guiding track.

The disclosed technology of the present invention can, as is obvious to the skilled person, also be used to identify other characteristics than printed indicia, e.g. paper signatures, produced or introduced into the paper or base material of the sheet-like item during its manufacturing process. Such paper signature can derive from the intrinsic properties imparted to the paper during the manufacturing process by the screen used for the dewatering of the paper pulp, and/or by other processes effectuated at the paper mill.

The possibility of introducing and detecting paper signatures along with printed indicia provides new opportunities for the machine-detecting of the type, as well as the origin of a banknote or another value or identity document. For example, if an Automatic Teller Machine (ATM) is to accept only a single generic type of banknotes, a thermic fingerprint sensor embedded in the ATM will be able to detect it easily based on the corresponding paper signature.

In a further embodiment of the invention, a thermic fingerprint sensor is embedded in an Automatic Teller Machine (ATM) for the identification of banknotes.

In general, said identification, allowing for the traceability of banknotes, can take place in two ways: identification at the group level e.g. identifying a denomination of banknote, on one hand, and at the item level, i.e. defining the genuineness and uniqueness of an individual banknote, on the other hand.

It was found that the letterpress-printed serial numbers of banknotes and other sheet-like items can also be read (decoded) from image data obtained with the help of a thermal fingerprint detector. The matching between the visible serial number of an individual banknote and its pre-recorded “signature”, such as a paper signature, intaglio printed indicia, etc., allows to check the banknote's individual identity. The pre-recorded “signatures” are those of the original items, which can be stored in a database.

ATMs are generally connected to inter-bank networks, enabling people to withdraw and to deposit money from or to their accounts, wherever. Banknote acceptors for depositing or automatic change need a reliable authentication of the accepted banknotes. At least one thermic fingerprint sensor can be embedded in an ATM and used according to the present invention, as a fast and simple tool to perform such banknote authentication.

In another application, at least one thermic fingerprint sensor is embedded in an AVM (Automatic Vending Machine). A vending machine dispenses merchandise or a transportation ticket when a customer supplies the required amount of money. The acceptance of fake banknote by AVMs is a recurrent problem. A thermic fingerprint sensor implemented in automatic vending machines for merchandise or public transportation tickets can efficiently contribute to solve this problem.

We claim:

1-36. (canceled)

37. Method for authenticating a sheet-like item including a pattern by means of a thermic sensor having a fingerprint detecting area, comprising the steps of:
a) putting a respective part of the sheet-like item in contact with, or sweeping it over a respective part of the detecting area of the sensor;
b) acquiring, by a processor, thermal image data reflecting tiny temperature differences of the sheet-like item associated with the pattern;
c) comparing the acquired thermal image data with reference data corresponding to an original item, hereby deriving an authenticity result.

38. Method according to claim 37, wherein the sensor is chosen from the group consisting of the thermic pyroelectric sensors, the thermic microbolometric sensors, and the thermic photoelectric sensors.

39. Method according to claim 38, wherein the sensor is chosen from the one-dimensional-array scanning sensors and the two-dimensional-array sensors.

40. Method according to claim 37, wherein said pattern is either an intrinsic property imparted to the item during the manufacturing process, or a printed feature contained on at least one of the recto and the verso sides of the sheet-like item.

41. Method according to claim 40, wherein said pattern is selected from the group consisting of the intaglio-printed patterns, the watermarks, the paper signatures, and the woven patterns.

42. Method according to claim 37, wherein said sheet-like item is selected from the group consisting of the papers, the plastics, the cardboards, the printed documents, the security documents, the banknotes, the value documents, the identity documents, the labels, and the textiles.

43. Method according claim 37, wherein said thermal image data is acquired from a single, first side of said item and said acquired thermal image data is representative of information present on both, a first and a second side of said item.
